(19) United States
(12) Patent Application Publication
(10) Pub. No.: US 2025/0364892 A1
(43) Pub. Date: Nov. 27, 2025

(54) DC-DC CONVERTER WITH REFERENCE FREQUENCY LOCKED MODULATION AND CONTROL METHOD THEREOF

(71) Applicant: BravoTek Electronics Co., Ltd., Hsinchu County (TW)

(72) Inventors: Wei-Hsin WEI, Hsinchu County (TW); Yu-Yu LIAO, Hsinchu County (TW); Wei-Lun HSIEH, Hsinchu County (TW)

(21) Appl. No.: 18/670,755

(22) Filed: May 22, 2024

(51) Int. Cl. H02M 1/00; H02M 3/07

(52) U.S. Cl. CPC H02M 1/0095; H02M 3/07

(57) ABSTRACT

The application provides a DC-DC converter and the control method thereof. A power stage converts input to output voltage. A FLM control circuit compares power stage's internal node voltage with a reference frequency signal to generate an FLM result. A candidate on-time is generated based on FLM result and a minimum on-time. A control logic generates on-time for controlling internal switches. The DC-DC converter operates in four load ranges. In a highest load range, a switching frequency is fixed. In a second highest load range, the switching frequency is decreased with decreasing load current. In a third highest load range, the switching frequency is fixed but the on-time is decreased with decreasing load current. In a lowest load range, the switching frequency is decreased with decreasing load current.

### TECHNICAL FIELD

The disclosure relates in general to a direct-current (DC)-DC converter with reference frequency locked modulation and a control method thereof.

### BACKGROUND

A DC-DC converter is used to convert direct current voltage from one level to another. The functions and importance of a DC-DC converter are as follows. (1) Power conversion efficiency: DC-DC converters can convert power from one voltage level to another with high efficiency. This means there is minimal energy loss during the conversion process, which helps improve the overall efficiency of the power system. (2) Power adaptation: In electronic devices, different components and modules often require different voltage levels to operate properly. DC-DC converters provide the appropriate voltage to each component, enabling them to function effectively. (3) Battery management: In mobile devices and battery-powered equipment, DC-DC converters manage the output voltage of the battery to ensure the device receives the necessary power and to maximize battery life. (4) System stability: Using DC-DC converters can ensure that the output voltage remains stable even when the input voltage fluctuates. This is crucial for many sensitive electronic devices and circuits, which require a constant power supply to operate normally. (5) Size and weight advantages: Compared to traditional linear regulators, DC-DC converters are typically smaller and lighter, which is particularly important in applications where space is limited or weight is a concern.

In summary, DC-DC converters play a crucial role in the design and operation of electronic devices. They provide essential functions for power management and energy conversion, enabling various applications to operate efficiently and stably.

Currently, AMOLED (Active-Matrix Organic Light-Emitting Diode) power chips use DC-DC converters to achieve good power efficiency. When displaying low gray scale images, the current driving the OLED is relatively low. However, if the operating voltage of the AMOLED (OVDD and OVSS) has insufficient ripple control, water ripple effects can occur.

To date, several prior technologies have attempted to reduce the water ripple effect in AMOLEDs. One conventional technique uses shorter Pulse Frequency Modulation (PFM) on-times or forces the DC-DC converter into Continuous Conduction Mode (CCM) to reduce output voltage ripple. Another conventional technique involves additionally using a low-dropout regulator (LDO) to suppress voltage ripple. However, both of these techniques lead to reduced power efficiency.

The cause of water ripple is the perturbation of the OLED driving current due to voltage ripple in OVDD or OVSS. If the frequency of the OVDD or OVSS voltage ripple is not synchronized with the screen scanning frequency, the perturbation of the OLED driving current will occur irregularly across the screen, resulting in water ripple effects.

If the voltage ripple of OVDD/OVSS at light load can be synchronized with the horizontal scanning signal HSYNC, the perturbation of the OLED driving current can also be synchronized with the HSYNC signal and thus become regular. This should allow the perturbation caused by OVDD/OVSS to shift from occurring anywhere on the screen to fixed positions. This fixed perturbation frequency, being higher than the visual persistence threshold, might go unnoticed. Alternatively, pixel compensation can be performed at these fixed perturbation positions to eliminate the effects of the disturbances.

However, traditional DC-DC converters, when aiming for high efficiency under light loads, operate the power circuit's switching transistors with a fixed on-time in Discontinuous Conduction Mode (DCM). The switching frequency decreases as the load current decreases, preventing synchronization with the horizontal scanning signal HSYNC.

Therefore, there needs a new control method for DC-DC converters that allows them to operate at light loads with switching frequencies that decrease to multiples (or a single multiple) of the HSYNC frequency as the load decreases. This method should start reducing the on-time to lock the switching frequency at a defined multiple (or single multiple) of the HSYNC frequency. Once the on-time is minimized, the switching frequency continues to decrease with the load. The term “minimized on-time” refers to the point at which the output voltage ripple of the DC-DC converter is sufficiently small to prevent water ripple effects on the panel.

### SUMMARY

According to one embodiment, a DC-DC converter with frequency-lock modulation is provided. The DC-DC converter with frequency-lock modulation comprises: a power stage converting an input voltage into an output voltage; a frequency-lock modulation (FLM) control circuit coupled to the power stage, the FLM control circuit receiving and comparing an internal node voltage of the power stage with a reference frequency signal to generate an FLM result, the internal node voltage representing a switching frequency; an on-time generation circuit coupled to the FLM control circuit, the on-time generation circuit generating a candidate on-time based on the FLM result; a minimum on-time generation circuit generating a minimum on-time; and a control logic connected to the power stage, the on-time generation circuit, and the minimum on-time generation circuit for generating an on-time based on the candidate on-time, the minimum on-time used for controlling an internal switches of the power stage. In a first load range, the DC-DC converter operates in a first mode where the switching frequency of the internal node voltage remains fixed; in a second load range, the DC-DC converter operates in a second mode where the switching frequency gradually decreases as a load current decreases; in a third load range, the DC-DC converter operates in a third mode where the switching frequency is fixed but the on-time gradually decreases as the load current decreases; and in a fourth load range, the DC-DC converter operates in the second mode, and the switching frequency gradually decreases as the load current decreases. The load current in the first load range is higher than that in the second load range, the load current in the second load range is higher than that in the third load range, and the load current in the third load range is higher than that in the fourth load range.

According to another embodiment, a control method for a DC-DC converter is provided. The control method comprises: converting an input voltage into an output voltage by power stage; receiving and comparing an internal node voltage of the power stage with a reference frequency signal by a frequency-lock modulation (FLM) control circuit to generate an FLM result, the internal node voltage representing a switching frequency; generating a candidate on-time based on the FLM result by an on-time generation circuit; generating a minimum on-time; and generating by a control logic an on-time based on the candidate on-time, the minimum on-time used for controlling an internal switches of the power stage. In a first load range, the DC-DC converter operates in a first mode where the switching frequency of the internal node voltage remains fixed; in a second load range, the DC-DC converter operates in a second mode where the switching frequency gradually decreases as a load current decreases; in a third load range, the DC-DC converter operates in a third mode where the switching frequency is fixed but the on-time gradually decreases as the load current decreases; and in a fourth load range, the DC-DC converter operates in the second mode, and the switching frequency gradually decreases as the load current decreases. The load current in the first load range is higher than that in the second load range, the load current in the second load range is higher than that in the third load range, and the load current in the third load range is higher than that in the fourth load range.

### BRIEF DESCRIPTION OF THE DRAWINGS

FIG. 1 illustrates a functional block diagram of a DC-DC converter with Reference Frequency Locked Modulation (FLM) according to an embodiment of this disclosure.

FIG. 2 shows a graph illustrating the relationship between the switching frequency and the load current of the DC-DC converter according to an embodiment of this disclosure.

FIG. 3 shows a schematic diagram illustrating the variation of the inductor current of the DC-DC converter according to an embodiment of this disclosure.

FIG. 4 shows a schematic diagram illustrating how the on-time is generated according to an embodiment of this disclosure.

FIGS. 5A to 5D respectively show several examples of the power stage.

FIG. 6 illustrates a schematic diagram of the inductor current according to one embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

One embodiment discloses a method for controlling the switch-on time and switching frequency of a DC-DC converter. The DC-DC converter has an input voltage and an output voltage. The control method includes: setting a switching frequency signal (V_{SW}) in Continuous Conduction Mode (CCM); setting a reference frequency signal (V_{HSYNC}) in Discontinuous Conduction Mode (DCM), where the reference frequency signal has a frequency lower than the rated switching frequency in the continuous conduction mode; a phase detector that detects the phase difference between the switching frequency signal and the reference frequency signal; a current generator that responds to the phase detection result from the phase detector to generate a current; an on-time generator that responds to the input voltage and output voltage, wherein when the DC-DC converter transitions from continuous conduction mode to discontinuous conduction mode, the on-time remains unchanged, causing the switching frequency to decrease as the load decreases; when the load further decreases, the on-time starts to reduce to maintain the switching frequency at or above the reference frequency signal; and control logic to ensure that the on-time always remains greater than or equal to a minimum on-time (generated by a minimum on-time generation circuit).

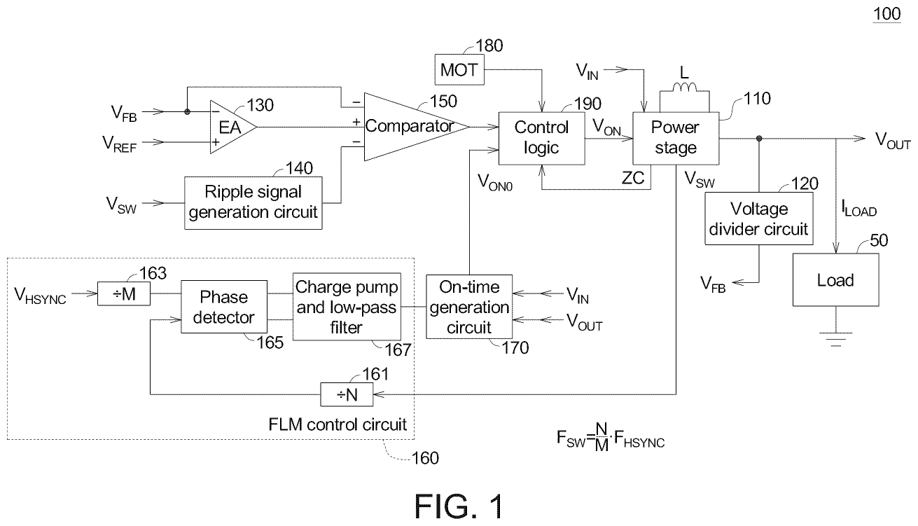

FIG. 1 illustrates a functional block diagram of a DC-DC converter with Reference Frequency Locked Modulation (FLM) according to an embodiment of this disclosure. The DC-DC converter 100 includes: a power stage 110, an inductor L, a voltage divider circuit 120, an error amplifier 130, a ripple signal generation circuit 140, a comparator 150, a frequency locked modulation (FLM) control circuit 160, an on-time generation circuit 170, a minimum on-time (MOT) generation circuit 180, and control logic 190. The frequency locked modulation control circuit 160 further includes: a first frequency divider 161, a second frequency divider 163, a phase detector 165, and a charge pump and low-pass filter 167. The DC-DC converter 100 provides a load current ILOAD to the load 50.

The power stage 110 converts the input voltage V_{IN} into the output voltage V_{OUT}. When the DC-DC converter 100 is a DC-DC converter, both the input voltage V_{IN} and the output voltage V_{OUT} are DC voltages.

The inductor L is selectively connected across the power stage 110.

The voltage divider circuit 120 is coupled to the power stage 110. The voltage divider circuit 120 divides the output voltage V_{OUT} into a feedback voltage V_{FB}.

The error amplifier 130 is coupled to the power stage 110 and/or the voltage divider circuit 120. The error amplifier 130 compares the feedback voltage V_{FB} with the reference voltage VREF and generates an error amplification result.

The ripple signal generation circuit 140 is used to generate a ripple signal, which simulates the inductor ripple current signal.

The positive input terminal of the comparator 150 is coupled to the error amplifier 130. The first negative input terminal of the comparator 150 is coupled to the ripple signal generation circuit 140, and the second negative input terminal of the comparator 150 is coupled to the feedback voltage V_{FB}. The comparator 150 receives the error amplification result from the error amplifier 130, the ripple signal generated by the ripple signal generation circuit 140, and the feedback voltage VFB, to produce a comparison result. If the comparator result is true (i.e., if the voltage at the positive input terminal of the comparator 150 is higher than the sum of the voltages at the two negative input terminals of the comparator 150), then the comparison result from the comparator 150 triggers the control logic 190 to send a fixed on-time signal (V_{ON}) to the power stage 110, connecting one end of the inductor L to the input voltage V_{IN} for inductor charging and energy storage. That is, the comparison result of the comparator 150 determines whether to trigger the control logic 190.

The frequency locked modulation control circuit 160 is coupled to the power stage 110. The frequency locked modulation control circuit 160 receives the internal node voltage V_{SW} of the power stage 110 (which will be further explained below) to control a branch current (I_{X}, which will also be explained below) of the on-time generation circuit 170.

The first frequency divider 161 of the frequency locked modulation control circuit 160 divides the internal node voltage V_{SW} of the power stage 110. The division factor of the first frequency divider 161 is N (N being a positive integer).

The second frequency divider 163 of the frequency locked modulation control circuit 160 divides a reference frequency signal V_{HSYNC}. The division factor of the second frequency divider 163 is M (M being a positive integer). The reference frequency signal V_{HSYNC} is the horizontal sync signal.

The phase detector 165 of the frequency locked modulation control circuit 160 is coupled to the first frequency divider 161 and the second frequency divider 163, to receive the division results from both. The phase detector 165 detects the phase of the division result from the first frequency divider 161 and the phase of the division result from the second frequency divider 163, to produce a phase detection result.

The charge pump and low-pass filter 167 of the frequency locked modulation control circuit 160 are coupled to the phase detector 165. The charge pump and low-pass filter 167 generate a charge pump voltage (V_{CP}, which will be further explained below) based on the phase detection result from the phase detector 165.

Essentially, the phase detector 165 and the charge pump and low-pass filter 167 can be regarded as a conventional phase-locked loop (PLL). Therefore, the details are omitted here.

The on-time generation circuit 170 is coupled to the frequency locked modulation control circuit 160. The on-time generation circuit 170 produces a candidate on-time based on the input voltage and output voltage, as well as the FLM result from the frequency locked modulation control circuit 160.

The minimum on-time generation circuit 180 is used to produce a minimum on-time (MOT). The minimum on-time MOT is fixed.

The control logic 190 is coupled to the power stage 110, the comparator 150, the on-time generation circuit 170, and the minimum on-time generation circuit 180. When the comparison result from the comparator 150 is true, the control logic 190 sends a fixed on-time signal (V_{ON}) to the power stage 110, connecting one terminal of the inductor L to the input voltage V_{IN} for inductor charging and energy storage. The control logic 190 selects the larger value between the candidate on-time V_{OND} from the on-time generation circuit 170 and the minimum on-time MOT from the minimum on-time generation circuit 180 to become the fixed on-time V_{ON}, and sends this fixed on-time V_{ON} to the power stage 110. The zero inductor current detection result ZC from the power stage 110 is also input to the control logic 190, enabling the DC-DC converter 100 to operate in Discontinuous Conduction Mode (DCM).

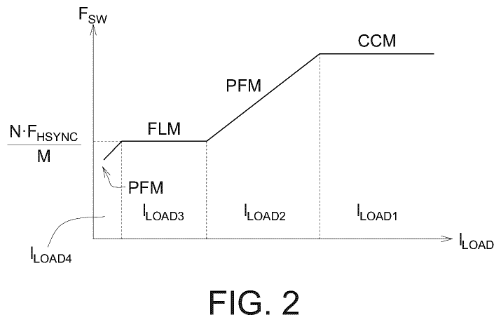

FIG. 2 shows a graph illustrating the relationship between the switching frequency F_{SW} and the load current ILOAD of the DC-DC converter 100 according to an embodiment of this disclosure. The switching frequency F_{SW} refers to the switching frequency within the power stage 110.

As shown in FIG. 2, when the load current ILOAD is in the first load range I_{LOAD1}, the DC-DC converter 100 operates in CCM mode. In CCM mode, the switching frequency F_{SW} remains fixed at a rated value.

When the load current ILOAD decreases from the first load range I_{LOAD1} to the second load range I_{LOAD2} (i.e., as the load of the DC-DC converter 100 gradually lightens), the DC-DC converter 100 operates in PFM mode. In this second load range, the switching frequency F_{SW} gradually decreases as the load decreases.

When the load current ILOAD further decreases to the third load range I_{LOAD3}, the DC-DC converter 100 operates in FLM mode. In FLM mode, the switching frequency F_{SW} is fixed at F_{SW}=N*F_{HSYNC}/M, but the on-time gradually shortens as the load current decreases.

When the on-time shortens to the minimum on-time MOT (or when the load current ILOAD decreases further to the fourth load range I_{LOAD4}), the DC-DC converter 100 operates again in PFM mode. In PFM mode, the switching frequency F_{SW} gradually decreases as the load current decreases.

As seen in FIG. 2, from the first load range to the fourth load range, the load current in the first load range is greater than the load current in the second load range, the load current in the second load range is greater than the load current in the third range, and the load current in the third range is greater than the load current in the fourth load range.

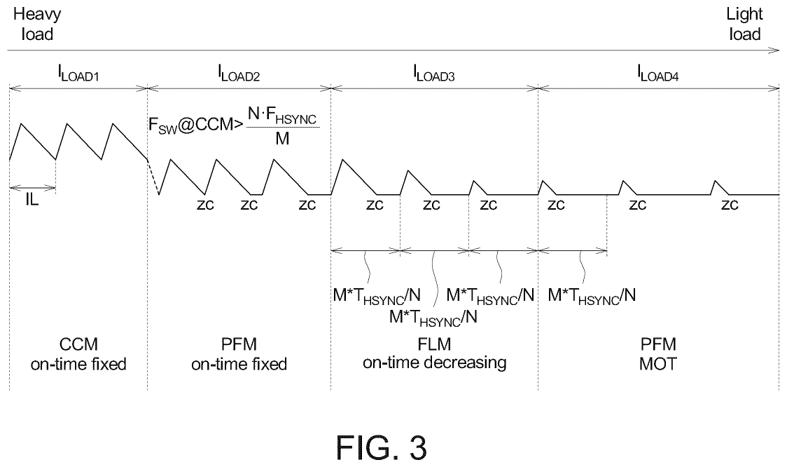

FIG. 3 shows a schematic diagram illustrating the variation of the inductor current IL and the load current ILOAD of the DC-DC converter 100 according to an embodiment of this disclosure. FIG. 3 should be viewed in conjunction with FIG. 2.

In the first load range I_{LOAD1}, which represents a heavy load, the DC-DC converter 100 operates in CCM mode. In CCM mode, the switching frequency F_{SW} remains fixed at a rated value, and the on-time remains unchanged.

In the second load range I_{LOAD2}, the switching frequency F_{SW} (F_{SW}@CCM) is still greater than N*F_{HSYNC}/M (where F_{HSYNC} represents the frequency of the horizontal sync signal), and the DC-DC converter 100 operates in PFM mode. In PFM mode, the switching frequency F_{SW} gradually decreases as the load decreases, but the on-time remains unchanged.

In the third load range I_{LOAD3}, the DC-DC converter 100 operates in FLM mode. In FLM mode, the switching frequency F_{SW} is fixed (T_{SW}=M*T_{HSYNC}/N), but the on-time gradually shortens, where T_{SW} represents the cycle of the switching frequency F_{SW}, and T_{HSYNC} is the cycle of the horizontal sync signal.

In the fourth load range I_{LOAD4}, when the on-time shortens to the minimum on-time MOT, the DC-DC converter 100 operates again in PFM mode. In PFM mode, the switching frequency F_{SW} gradually decreases as the load decreases.

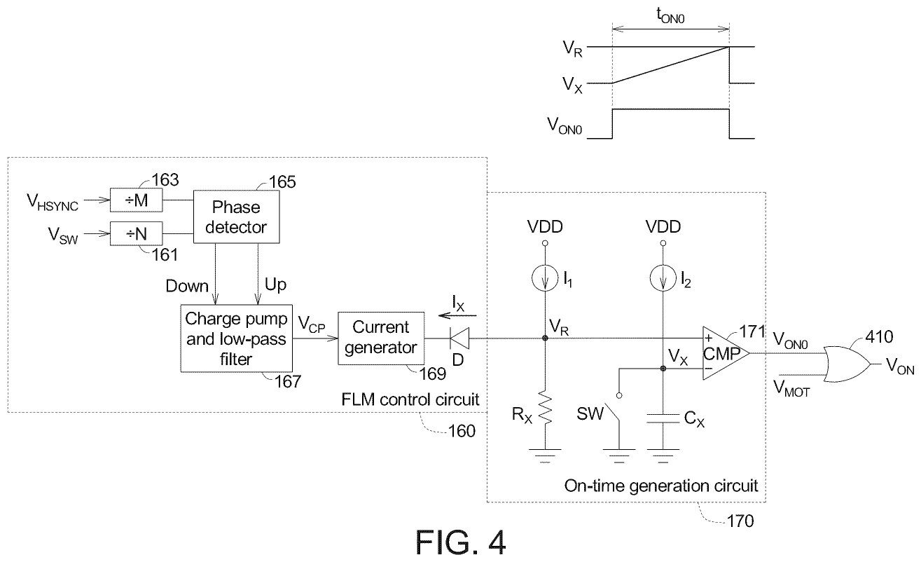

FIG. 4 shows a schematic diagram illustrating how the on-time is generated according to an embodiment of this disclosure. The frequency-locked modulation control circuit 160 further includes a current generator 169 coupled to the charge pump and low-pass filter 167 for converting the charge pump voltage V_{CP} generated by the charge pump and low-pass filter 167 into a current to prevent the diode D in the frequency-locked modulation control circuit 160 from reverse conduction (i.e., in FIG. 4, the branch current I_{X} is either 0 or greater than 0, and the branch current I_{X} is never negative). Specifically, when the branch current I_{X} is 0, the candidate on-time t_{OND} is at the maximum value; when the branch current I_{X} gradually increases (above 0), the candidate on-time t_{OND} gradually decreases. In other words, the frequency-locked modulation control circuit 160 generates different candidate on-times t_{OND} by controlling the value of the branch current I_{X}.

The on-time generation circuit 170 includes: current sources I₁ and I₂, a resistor R_{X}, a capacitor C_{X}, a switch SW, and a comparator 171.

The current sources I₁ and I₂ provide reference currents I₁ and I₂, respectively.

The resistor R_{X} is coupled to the current source I₁. The node voltage V_{R} can be expressed as: V_{R}=(I₁−I_{X})*R_{X}.

The capacitor C_{X} is coupled to the current source I₂.

The switch SW is coupled to the capacitor C_{X}. When the switch SW is on, the capacitor C_{X} is discharged, making the node voltage V_{X} equal to 0.

The comparator 171 compares the node voltages V_{R} and V_{X} to generate the candidate on-time voltage V_{OND} corresponding to the candidate on-time t_{OND}.

A logic gate 410 (e.g., an OR gate) receives the candidate on-time voltage V_{OND} and the minimum on-time voltage V_{MOT} generated by the minimum on-time generation circuit 180 to produce the on-time voltage V_{ON}, where the minimum on-time voltage V_{MOT} corresponds to the minimum on-time MOT, and the on-time voltage V_{ON} corresponds to the on-time T_{ON}. When the candidate on-time voltage V_{OND} is greater than or equal to the minimum on-time voltage V_{MOT}, the logic gate 410 selects the candidate on-time voltage V_{OND} as the on-time voltage V_{ON}; when the candidate on-time voltage V_{OND} is less than the minimum on-time voltage V_{MOT}, the logic gate 410 selects the minimum on-time voltage V_{MOT} as the on-time voltage V_{ON}. The logic gate 410 is located within the control logic 190.

The details of generating the on-time will now be explained.

The followings are equations (1)-(4).

$${{C}_{X}}^{*} {R}_{X} = {{I}_{2}}^{*} {t}_{ON 0} \qquad ( 1 )$$

$${V}_{R} = {( {I}_{1} - {I}_{X} )}^{*} {R}_{X} \qquad ( 2 )$$

$${t}_{ON 0} = {{R}_{X}}^{*} {{C}_{X}}^{*} ( {I}_{1} - {I}_{X} ) / {I}_{2} \qquad ( 3 )$$

$${t}_{ON 0} = {{R}_{X}}^{*} {{C}_{X}}^{*} ( {I}_{1} ( {V}_{IN} , {V}_{OUT} ) - {I}_{X} ) / {I}_{2} ( {V}_{IN} , {V}_{OUT} ) \qquad ( 4 )$$

In equation (1), during the candidate on-time, the charging amount to the capacitor C_{X} by the current source I₂ is equal to C_{X}*V_{R}, when the voltages at the two input terminals of the comparator 171 are equal.

Equation (2) represents the voltage at node V_{R}.

Substituting equation (2) into equation (1) yields equation (3).

As for equation (4), it represents the currents I₁ and 12 as functions of the input voltage V_{IN} and the output voltage V_{OUT}, I₁(V_{IN}, V_{OUT})−I_{X})/I₂(V_{IN}, V_{OUT}).

First, assume the branch current I_{X}=0. From equation (3), it can be understood that the candidate on-time t_{OND} depends only on the input voltage V_{IN}, the output voltage V_{OUT}, the resistor R_{X} and the capacitor C_{X}. This candidate on-time t_{OND} is designed to allow the DC-DC converter 100 to operate at a fixed frequency in CCM mode.

When the divided result (V_{SW}/N) of the desired switching frequency signal (V_{SW}) is lower than the divided result (V_{HSYNC}/M) of the reference frequency signal (V_{HSYNC}), then the phase detector 165, along with the charge pump and low-pass filter 167, will slightly increase the charge pump voltage V_{CP}, causing the branch current I_{X} to be higher. In this case, the candidate on-time t_{OND} is reduced to lock the switching frequency F_{SW}.

The on-time t_{OND} is the duty cycle of the on-time voltage V_{ON}.

In other words, at the initial operation, I_{X}=0, the current source I₁ charges the resistor R_{X} to get V_{R}=IR*R_{X}. Meanwhile, the switch SW is on to discharge the node V_{X} to OV, and the current source I₂ charges the capacitor C_{X}. When the node voltage V_{R} is higher than the node voltage V_{X}, the comparator 171 produces a high-level V_{OND}. V_{OND} remains high until V_{R}=V_{X}.

Assuming I_{X}=0, R_{X}, C_{X}, I₁ and 12 are adjusted according to the t_{OND} equation to keep the frequency of t_{OND}.

As I_{X} is larger, t_{OND} decreases. Due to the diode D, the branch current I_{X} is never negative.

In CCM mode, when the switching voltage V_{SW} has a frequency higher than the horizontal scan signal V_{HSYNC}, the charge pump and low-pass filter 167 will decrease the charge pump voltage V_{CP}. When the charge pump voltage V_{CP} drops to its minimum, the branch current I_{X}=0 and the candidate on-time voltage V_{OND} remains unaffected, maintaining the original on-time.

In the second load range I_{LOAD2} shown in FIG. 3, the frequency of the switching voltage V_{SW} decreases as the load decreases (i.e., the switching frequency F_{SW} decreases). When the divided result (V_{SW}/N) of the desired switching frequency (V_{SW}) is lower than the divided result (V_{HSYNC}/M) of the reference frequency signal (V_{HSYNC}), the charge pump and low-pass filter 167 begin to increase the charge pump voltage V_{CP}. Consequently, the branch current I_{X} starts to exceed 0. In this scenario, the on-time decreases as the load current decreases (entering the third load range I_{LOAD3} shown in FIG. 3), until the on-time is less than or equal to the minimum on-time (t_{OND}≤t_{MOT}) and entering the fourth load range I_{LOAD4} in FIG. 3. When the load current continues to decrease, the switching frequency F_{SW} also decreases accordingly.

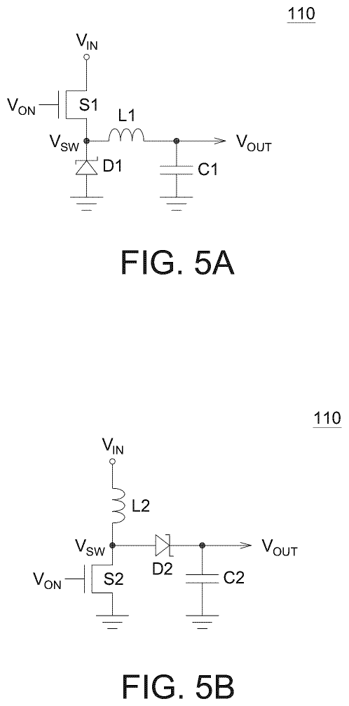

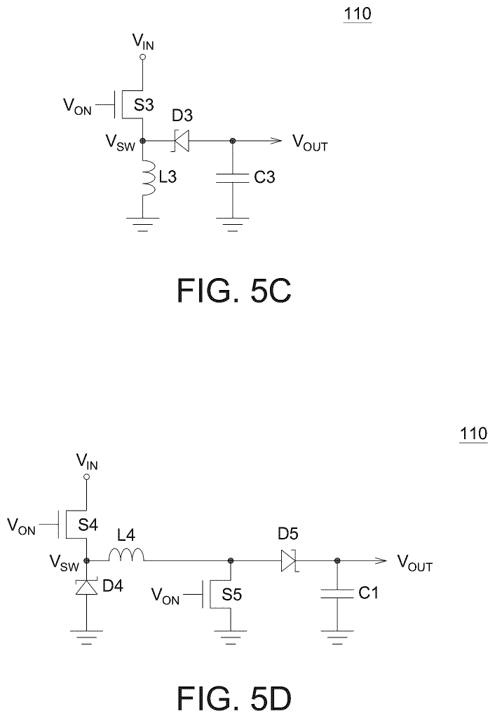

FIGS. 5A to 5D respectively show several examples of the power stage.

As shown in FIG. 5A, the power stage 110 includes: a switch S1, a Schottky diode D1, an inductor L1 and a capacitor C1. The power stage 110 in FIG. 5A is a buck-type power stage.

As shown in FIG. 5B, the power stage 110 includes: a switch S2, a Schottky diode D2, an inductor L2, and a capacitor C2. The power stage 110 in FIG. 5B is a boost-type power stage.

As depicted in FIG. 5C, the power stage 110 includes a switch S3, a Schottky diode D3, an inductor L3, and a capacitor C3. The power stage 110 in FIG. 5C is an inverting-type power stage.

As illustrated in FIG. 5D, the power stage 110 comprises: switches S4 and S5, Schottky diodes D4 and D5, an inductor L4, and a capacitor C4. The power stage 110 in FIG. 5D is a buck-boost-type power stage.

The details of FIGS. 5A to 5D are not specifically described here.

The power stage 110 is not limited to the embodiments depicted in FIGS. 5A to 5D. Although FIGS. 5A to 5D show asynchronous power stages, other embodiments of the present invention may also use synchronous power stages (replacing Schottky diodes with power switches), all within the scope of the present invention.

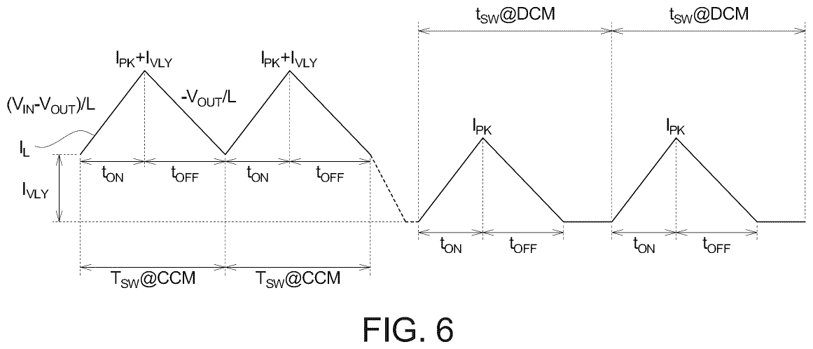

FIG. 6 illustrates a schematic diagram of the inductor current IL according to one embodiment of the present invention. Here, the explanation is based on the assumption that the power stage 110 is a synchronous buck power stage. In FIG. 6, the power stage 110 operates in CCM mode during the first two cycles, while operates in DCM mode during the next two cycles. I_{PK} refers to the peak value of the inductor current IL.

From FIG. 6, it can be derived that the peak value I_{PK} of the inductor current IL can be expressed in equation (5) using the on-time t_{ON} and off-time t_{OFF} (where t_{OFF} refers to the off-time of the internal switches of the buck power stage).

$${I}_{PK} = \frac{{V}_{IN} - {V}_{OUT}}{L} \cdot {t}_{ON} = \frac{{V}_{OUT}}{L} \cdot {t}_{OFF} \qquad ( 5 )$$

From equation (5), the relationship between the on-time t_{ON} and off-time t_{OFF} can be derived as shown in equation (6).

$${t}_{OFF} = \frac{{V}_{IN} - {V}_{OUT}}{{V}_{OUT}} \cdot {t}_{ON} \qquad ( 6 )$$

Q₀ represents the charge accumulated in the inductor L during the on-time t_{ON}, which can be expressed as shown in equation (7).

$${Q}_{O} = {\int }_{0}^{{t}_{ON}} ( {I}_{VLY} + \frac{{V}_{IN} - {V}_{OUT}}{L} \cdot t ) dt + {\int }_{0}^{{t}_{OFF}} ( {I}_{VLY} + {I}_{PK} - \frac{{V}_{OUT}}{L} \cdot t ) dt = \frac{{V}_{IN}}{{V}_{OUT}} \cdot ( {I}_{VLY} + \frac{{V}_{IN} - {V}_{OUT}}{L} {t}_{ON} ) \cdot {t}_{ON} \qquad ( 7 )$$

When operating in CCM, the output current is as

$${I}_{O @ CCM} = \frac{{Q}_{o}}{{T}_{SW @ CCM}} = {F}_{SW @ CCM} \cdot \frac{{V}_{IN}}{{V}_{OUT}} \cdot ( {I}_{VLY} + \frac{{V}_{IN} - {V}_{OUT}}{L} {t}_{ON} ) \cdot {t}_{ON} .$$

When operating in DCM, the output current is as

$${I}_{O @ DCM} = \frac{{Q}_{o}}{{T}_{SW @ DCM}} = {f}_{SW @ DCM} \cdot \frac{{V}_{IN}}{{V}_{OUT}} \cdot \frac{{V}_{IN} - {V}_{OUT}}{L} \cdot {t}_{ON}^{2} .$$

In PFM mode, the on-time t_{ON} is fixed, and the switching frequency F_{SW} is changed to obtain the output current.

In FLM mode, the switching frequency F_{SW} is fixed, but the on-time t_{ON} is shortened to obtain the output current.

In conventional techniques, traditional DC-DC converters operate the power switch with a fixed on-time at light loads. As the load decreases, the switching frequency also decreases, causing it to be out of sync with the horizontal sync signal V_{HSYNC}, resulting in undesirable effects such as ripple generation.

Therefore, in one embodiment of the present invention, as the load decreases, the switching frequency decreases to a multiple frequency (or single frequency) of the horizontal sync signal V_{HSYNC}, and then the on-time is reduced. Through this method, the switching frequency of the DC-DC converter can synchronize with a multiple frequency (or single frequency) of the horizontal sync signal V_{HSYNC} until the on-time is minimized, and then the switching frequency decreases as the load decreases. The “minimum on-time” refers to the point where the output voltage ripple of the DC-DC converter is small enough not to produce visible ripples on the panel.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A DC-DC converter with frequency-lock modulation, comprising:
a power stage converting an input voltage into an output voltage;
a frequency-lock modulation (FLM) control circuit coupled to the power stage, the FLM control circuit receiving and comparing an internal node voltage of the power stage with a reference frequency signal to generate an FLM result, the internal node voltage representing a switching frequency;
an on-time generation circuit coupled to the FLM control circuit, the on-time generation circuit generating a candidate on-time based on the FLM result;
a minimum on-time generation circuit generating a minimum on-time; and
a control logic connected to the power stage, the on-time generation circuit, and the minimum on-time generation circuit for generating an on-time based on the candidate on-time, the minimum on-time used for controlling an internal switches of the power stage,
wherein
in a first load range, the DC-DC converter operates in a first mode where the switching frequency of the internal node voltage remains fixed;
in a second load range, the DC-DC converter operates in a second mode where the switching frequency gradually decreases as a load current decreases;
in a third load range, the DC-DC converter operates in a third mode where the switching frequency is fixed but the on-time gradually decreases as the load current decreases; and
in a fourth load range, the DC-DC converter operates in the second mode, and the switching frequency gradually decreases as the load current decreases;
the load current in the first load range is higher than that in the second load range, the load current in the second load range is higher than that in the third load range, and the load current in the third load range is higher than that in the fourth load range.

2. The DC-DC converter of claim 1 further comprising:
a voltage divider circuit coupled to the power stage for dividing the output voltage to provide a feedback voltage;
an error amplifier coupled to the power stage and the voltage divider circuit for comparing the feedback voltage with a reference voltage and generating an error amplification result;
a ripple signal generation circuit generating a ripple signal; and
a comparator coupled to the error amplifier, the ripple signal generation circuit, and the control logic, the comparator receiving the error amplification result, the ripple signal, and the feedback voltage to generate a comparison result, the comparison result input to the control logic.

3. The DC-DC converter of claim 2, wherein the frequency-lock modulation control circuit includes:
a first frequency divider coupled to the power stage, dividing the internal node voltage of the power stage to generate a first division result;
a second frequency divider dividing a reference frequency signal to generate a second division result;
a phase detector coupled to the first and second frequency dividers, detecting phases of the first division result and the second division result to generate a phase detection result;
a charge pump and low-pass filter coupled to the phase detector to generate a charge pump voltage; and
a current generator coupled to the charge pump and low-pass filter to convert the charge pump voltage into a current.

4. The DC-DC converter of claim 3, wherein
the current generated by the current generator controls a branch current of the on-time generation circuit;
when the branch current is 0, the candidate on-time is a maximum value; and
as the branch current increases, the candidate on-time decreases gradually.

5. The DC-DC converter of claim 4, wherein the minimum on-time is fixed.

6. The DC-DC converter of claim 5, wherein the control logic is configured as:
when the candidate on-time is higher than the minimum on-time, the control logic selects the candidate on-time as the on-time, and
when the candidate on-time is lower than the minimum on-time, the control logic selects the minimum on-time as the on-time.

7. The DC-DC converter of claim 4, wherein the first mode is a continuous conduction mode (CCM), the second mode is a pulse frequency modulation mode (PFM), and the third mode is a frequency-lock modulation mode (FLM).

8. A control method for a DC-DC converter, the control method comprising:
converting an input voltage into an output voltage by power stage;
receiving and comparing an internal node voltage of the power stage with a reference frequency signal by a frequency-lock modulation (FLM) control circuit to generate an FLM result, the internal node voltage representing a switching frequency;
generating a candidate on-time based on the FLM result by an on-time generation circuit;
generating a minimum on-time; and
generating by a control logic an on-time based on the candidate on-time, the minimum on-time used for controlling an internal switches of the power stage,
wherein
in a first load range, the DC-DC converter operates in a first mode where the switching frequency of the internal node voltage remains fixed;
in a second load range, the DC-DC converter operates in a second mode where the switching frequency gradually decreases as a load current decreases;
in a third load range, the DC-DC converter operates in a third mode where the switching frequency is fixed but the on-time gradually decreases as the load current decreases; and
in a fourth load range, the DC-DC converter operates in the second mode, and the switching frequency gradually decreases as the load current decreases;
the load current in the first load range is higher than that in the second load range, the load current in the second load range is higher than that in the third load range, and the load current in the third load range is higher than that in the fourth load range.

9. The control method for the DC-DC converter of claim 8, further comprising:
dividing the output voltage to provide a feedback voltage;
comparing the feedback voltage with a reference voltage and generating an error amplification result;
generating a ripple signal; and
receiving the error amplification result, the ripple signal, and the feedback voltage to generate a comparison result, the comparison result input to the control logic.

10. The control method for the DC-DC converter of claim 9, wherein dividing the internal node voltage of the power stage to generate a first division result;
dividing a reference frequency signal to generate a second division result;
detecting phases of the first division result and the second division result to generate a phase detection result;
generating a charge pump voltage; and
converting the charge pump voltage into a current.

11. The control method for the DC-DC converter of claim 10, wherein
the current generated by the current generator controls a branch current;
when the branch current is 0, the candidate on-time is a maximum value; and
as the branch current increases, the candidate on-time decreases gradually.

12. The control method for the DC-DC converter of claim 11, wherein the minimum on-time is fixed.

13. The control method for the DC-DC converter of claim 12, wherein the control logic is configured as:
when the candidate on-time is higher than the minimum on-time, the control logic selects the candidate on-time as the on-time, and
when the candidate on-time is lower than the minimum on-time, the control logic selects the minimum on-time as the on-time.

14. The control method for the DC-DC converter of claim 11, wherein the first mode is a continuous conduction mode (CCM), the second mode is a pulse frequency modulation mode (PFM), and the third mode is a frequency-lock modulation mode (FLM).
